(19) United States
(12) Patent Application Publication
(10) Pub. No.: US 2006/0069543 A1
(43) Pub. Date: Mar. 30, 2006

(54) Emulated universal serial bus input devices

(76) Inventors: Imtiaz Sajwani, Hillsboro, OR (US); Dzung Tran, Beaverton, OR (US); Shailendra Sinha, Hillsboro, OR (US)

Correspondence Address: BUCKLEY, MASCHOFF, TALWALKAR LLC, 5 ELM STREET, NEW CANAAN, CT, 06840, US

(21) Appl. No.: 10/948,988

(22) Filed: Sep. 24, 2004

(51) Int. Cl. G06F 9/455

(52) U.S. Cl. 703/24

(57) ABSTRACT

According to some embodiments, systems and methods may be utilized to provide USB bridging over IP for a gaming client. In some embodiments, a method may include receiving information associated with an emulated universal serial bus input device. The method may further include processing the received information in accordance with an application to produce application information associated with the application and providing the application information. In some embodiments, the application information may be provided to a gaming client.

### BACKGROUND

Electronic devices may be used to execute various types of applications, and some applications may receive and process signals from input components. For example, a Personal Computer (PC) might execute a gaming application that receives signals from a keyboard and/or a joystick. Often the input components are configured in accordance with the Universal Serial Bus (USB) interface standard as described in the USB Specification Revision 2.0 (2000). Many electronic devices, such as Personal Digital Assistant (PDA) devices and wireless telephones, however, are not equipped with USB interfaces and are therefore unable to execute certain applications. Further, a standard USB interface might drain a substantial amount of power in a portable electronic device (e.g., and reduce battery life for the device).

### BRIEF DESCRIPTION OF THE DRAWINGS

FIG. 1 is a block diagram of a system according to some embodiments.

FIG. 2 is a block diagram of a system according to some embodiments.

FIG. 3 is a flow diagram of a method according to some embodiments.

FIG. 4 is a block diagram of a system according to some embodiments.

FIG. 5 is a flow diagram of a method according to some embodiments.

FIG. 6 is a block diagram of a system according to some embodiments.

FIG. 7 is a block diagram of a system according to some embodiments.

### DETAILED DESCRIPTION

Some embodiments herein are associated with “information” or “data”. As used herein, the terms “information” and “data” may be used interchangeably and may refer to any data, text, voice, video, image, message, bit, packet, pulse, tone, waveform, and/or other type or configuration of signal and/or information. Information may be or include information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encrypted, and/or otherwise packaged or manipulated in accordance with any method that is or becomes known.

In addition, some embodiments described herein are associated with “information indicative of” or “indicia” of information associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information.

Some embodiments described herein are associated with a “network device”. As used herein, the phrase “network device” may refer to any device that can communicate via a network. Examples of network devices include a PC, a workstation, a server, a printer, a scanner, a facsimile machine, a copier, a PDA, a storage device (e.g., a disk drive), a hub, a router, a switch, and a communication device (e.g., a modem, a wireless phone, etc.). Network devices may comprise one or more network components, such as a Static Random Access Memory (SRAM) device or module, a network processor, and a network communication path, connection, port, or cable.

In addition, some embodiments are associated with a “network” or a “communication network”. As used herein, the terms “network” and “communication network” may be associated with the transmission of messages, packets, signals, and/or other forms of information between and/or within one or more network devices. By way of example, a network may be configured to operate in accordance with the Fast Ethernet LAN transmission standard 802.3-2002® published by the Institute of Electrical and Electronics Engineers (IEEE).

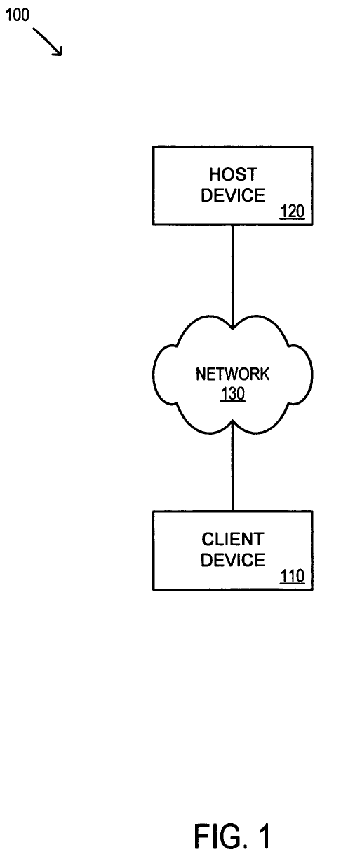

Referring first to FIG. 1, a block diagram of a system 100 according to some embodiments is shown. The various systems described herein are depicted for use in explanation, but not limitation, of described embodiments. Different types, layouts, quantities, and configurations of any of the systems described herein may be used without deviating from the scope of some embodiments. Fewer or more components than are shown in relation to the systems described herein may be utilized without deviating from some embodiments.

The system 100 may comprise, for example, a client device 110 in communication with a host device 120 via a network 130. The client device 110 may, for example, be the host device 120 via the network 130. The network 130 may be or include any quantity, configuration, and/or type of network that is or becomes known or practicable. In some embodiments, the network 130 may be a wired and/or wireless IP network. Either or both of the client device 110 and the host device 120 may include, be included within, and/or may otherwise be associated with a computing and/or mobile electronics device such as a PC, a notebook computer, a PDA, and/or a wireless telephone or other device (e.g., a network device).

In some embodiments, the client device 110 may be a mobile electronic device that is not equipped with and/or otherwise provided with a USB interface. For example, the client device 110 may be a wireless telephone that does not have USB functionality (e.g., in which case a USB joystick cannot be connected to the client device 110). According to some embodiments, the host device 120 may be a PC and/or other network device that is equipped with USB functionality. The host device 120 may, for example, be a PC or notebook computer having one or more USB ports and/or a USB chipset for providing an interface with USB devices (e.g., a USB joystick can be connected to the host device 120).

According to some embodiments, the client device 110 may interface with the host device 120 (e.g., via the network 130) to provide USB functionality to the client device 110. The client device 110 may, for example, be capable of interfacing with an application running on the host device 120 that accepts and/or requires USB inputs. In some embodiments, the client device 110 may connect to the host device 120 and provide an input to the host device 120 (e.g., via a keypad and/or other input device associated with the client device 110). The input may, according to some embodiments, be emulated as a USB output to the host device 120.

A keypad input from the client device 110 may, for example, be received as a USB packet by the host device 120 and may be processed as a USB output from an emulated USB device (e.g., a USB joystick). In other words, the output received from the client device 110 may be viewed and/or treated as an output from a USB device connected to the host device 130. Further, the application running on the host device 120 may be interfaced with the client device 110 to provide application output to the client device 110. As an example, a gaming application running on the host device 120 may be “played” via the client device 110 by using the host device 120 as a USB interface (e.g., USB bridging). In some embodiments, the host device 120 may provide remote USB bridging.

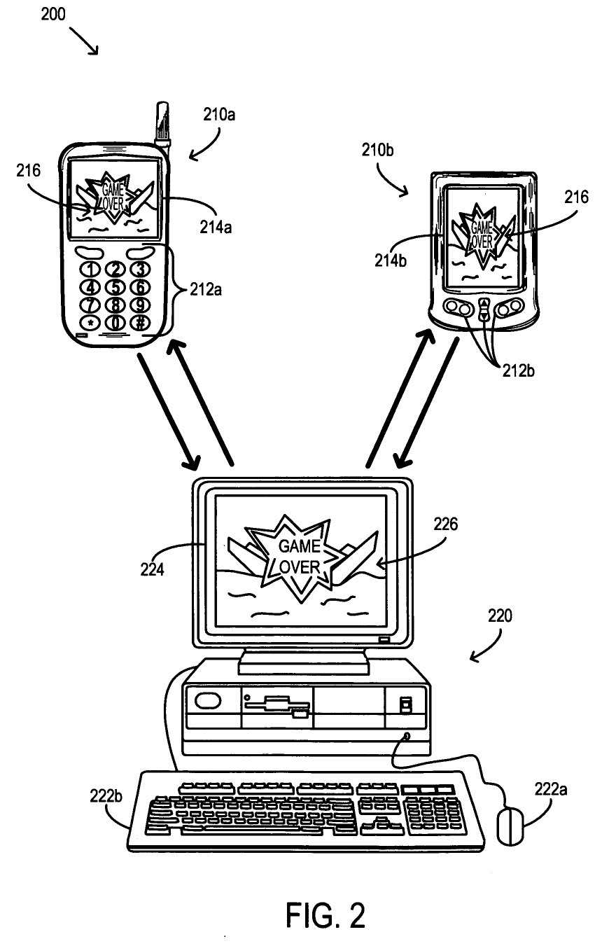

Referring in more detail to FIG. 2, a block diagram of a system 200 according to some embodiments is shown. The system 200 may include, according to some embodiments, one or more client devices 210a-b. The client devices 210a-b may include, for example, input components 212a-b, display components 214a-b, and/or client outputs 216 (e.g., graphics and/or sounds). The system 200 may also or alternatively include one or more host devices 220. In some embodiments, the host device 220 may include one or more input components 222a-b, a display component 224, and/or application outputs 226 (e.g., graphics and/or sounds). The client devices 210a-b and the host device 220 may, according to some embodiments, be coupled, connected, and/or otherwise in communication (e.g., via a network such as network 130). In some embodiments, the components 210, 220 of the system 200 may be similar in configuration and/or functionality to the similarly-named components described in conjunction with FIG. 1. In some embodiments, fewer or more components than are shown in FIG. 2 may be included in the system 200.

According to some embodiments, an application (such as a gaming application) may be executed via the host device 220 and may be interfaced with (e.g., “played”) via the client devices 210a-b. The client devices 210a-b may, for example, not be equipped with USB functionality, yet it may be desirable to use the client devices 210a-b to execute and/or interface with an application that accepts and/or requires USB outputs. The first client device 210a may, in some embodiments, be a wireless telephone such as a cellular telephone. The second client device 210b may, for example, be a PDA or other handheld computing device. Neither the wireless telephone 210a nor the PDA device 210b may, according to some embodiments, be capable of directly interfacing with USB devices and/or USB components. In some embodiments, the host device 220 may be utilized to facilitate and/or substantially allow interaction between the client devices 210a-b and an application that utilizes USB outputs.

As an example, a user of the wireless telephone 210a may desire to play a game (e.g., a multi-player game) with a user of the PDA device 210b (and/or a user of the host device 220). The game may accept and/or require USB output (e.g., from a USB joystick, mouse, and/or keyboard) for game execution. Accordingly, the client devices 210a-b may, in some embodiments, require the assistance of the host device 220 to interface with the gaming application. In some embodiments, the client devices 210a-b may identify, search for, discover, and/or otherwise determine the existence and/or address of the host device 220. In the case that the devices 210a-b, 220 communicate via Bluetooth® technology, for example, the client devices 210a-b and or the host device 220 may conduct wireless discovery of Bluetooth®-enabled devices within an operational range.

In some embodiments, a gaming session may be initiated in the case that the client devices 210a-b and the host device 220 are coupled and/or otherwise establish communication (e.g., upon device discovery). For example, the host device 220 may initiate the gaming application and/or load one or more drivers to support the interface between the host device 220 and the client devices 210a-b. In some embodiments, the client devices 210a-b may be emulated as USB devices connected to the host device 220. The host device 220 may, for example, load a USB joystick (or other device) driver to support the client devices 210a-b. In other words, the client devices 210a-b may appear to the host device 220 to be USB devices, and the appropriate driver for those devices may be loaded and/or otherwise identified and/or determined. In some embodiments, input components 222a-b may be directly connected to the host device 220. The pointing device 222a and/or the keyboard device 222b may, for example, allow a user to interface with the host device 220 (e.g., to participate in the game and/or to manage the USB bridging).

According to some embodiments, the input components 212a-b of the client devices 210a-b may be mapped to the emulated input components (e.g., the emulated USB joystick and/or other components). For example, the wireless telephone 210a may include the input component 212a. The input component 212a may, for example, be an alpha-numeric keypad such as is typical of wireless telephones. In some embodiments, the keys of the keypad 212a may be mapped to outputs of the emulated USB device associated with the wireless telephone 210a. For example, the key for the number “two” may be mapped to the positive vertical axis (or first axis) of an emulated USB joystick. Other keys may be similarly mapped so that, according to some embodiments, the keypad may be used to provide outputs representing the outputs that would be possible if an actual USB joystick were being used. Similarly, the PDA device 210b may include the input component 212b. The input component 212b may include, for example, various buttons and/or a small directional keypad. The directions of the directional keypad 212b may, in some embodiments, be mapped to the similar directions that a USB joystick and/or game pad would produce.

According to some embodiments, the users of the client devices 210a-b may utilize the input components 212a-b to provide output to the gaming application running on the host device 220. In the case that the user of the wireless telephone 210a presses the key for the number two, for example, an output associated with the positive vertical axis of the emulated USB joystick may be created. In some embodiments, the output may be created, stored, converted to, and/or otherwise associated with a USB packet. The USB packet may, according to some embodiments, be sent over the IP network to the host device 220. The host device 220 may receive the USB packet and may process the USB packet as if it were a standard USB output from an actual USB joystick (e.g., using the necessary driver). The USB output may be provided to the gaming application and may, for example, be processed by the gaming application as if it were received from an actual USB joystick and/or other USB device.

In some embodiments, the gaming application may produce application output 226 based at least in part on the emulated USB output received from the client devices 210a-b. In some embodiments, the gaming application output 226 may be presented via the display component 224 (e.g., for graphics and/or video) of the host device 220. In a flight simulation gaming application for example, the positive vertical axis of the emulated USB joystick may be associated with negative elevator activity of a simulated aircraft (e.g., tending to make the aircraft dive). The gaming application may accordingly provide graphics, sounds, and/or other information associated with the updated status of the aircraft and/or the simulated environment. The gaming application output 226 may, according to some embodiments, be provided by the host device 220 to the client devices 210a-b. For example, the client devices 210a-b may include display components 214a-b and/or other components such as speakers (not shown). The gaming application output 226 may be transmitted, for example, to the client devices 210a-b over the IP network.

According to some embodiments, the gaming application output 226 may be presented as client output 216 on the client devices 210a-b (e.g., via the display components 214a-b). The client devices 210a-b may, for example, include a client-side application such as a gaming client and/or a thin gaming client that provides the gaming application output 226 to the client devices 210a-b as client output 216. In some embodiments, processing may continue and/or repeat to allow the client devices 210a-b to interface with the gaming application as is appropriate for gaming execution. In other words, the interface between the client devices 210a-b and the gaming application running on the host device 220 may be substantially frequent to permit substantially uninterrupted game performance.

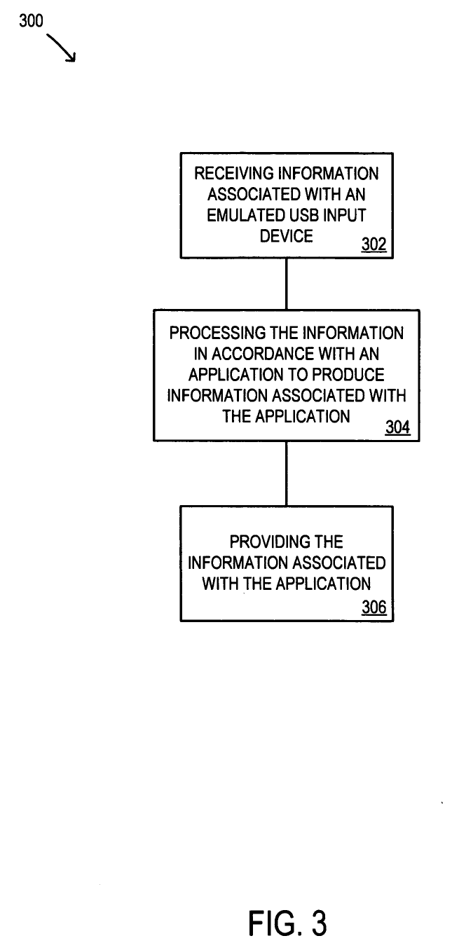

Referring now to FIG. 3, a method 300 according to some embodiments is shown. In some embodiments, the method 300 may be conducted by and/or by utilizing the systems 100, 200 and/or may be otherwise associated with the systems 100, 200 and/or any of the system components described in conjunction with any of FIG. 1 and/or FIG. 2. The method 300 may, for example, be performed by and/or otherwise associated with the host device 120, 220 described herein. The flow diagrams described herein do not necessarily imply a fixed order to the actions, and embodiments may be performed in any order that is practicable. Note that any of the methods described herein may be performed by hardware, software (including microcode), firmware, manual means, or any combination thereof. For example, a storage medium may store thereon instructions that when executed by a machine result in performance according to any of the embodiments described herein.

In some embodiments, the method 300 may begin at 302 by receiving information associated with an emulated USB input device. A host device (e.g., the host device 120, 220) such as a PC may, for example, receive information from a network device. The network device may, according to some embodiments, be or include a client device such as one or more of the client devices 110, 210 described in conjunction with FIG. 1 and/or FIG. 2. In some embodiments, the information may include a USB packet sent via an IP network from a client device. The information may, for example, be information indicative of an emulated USB output associated with the client device. The USB packet and/or USB output may, according to some embodiments, represent and/or include information associated with an input entered into the client device (e.g., via an input component 212).

The method 300 may continue, for example, by processing the information in accordance with an application to produce information associated with the application, at 304. The information received at 302 (e.g., from a client device) may, for example, be provided to an application such as a gaming application. The gaming application may utilize the received information to execute the game and/or otherwise produce output associated with the application (e.g., graphics, sounds, and/or a score). In the case that the received information includes a USB packet and/or output, for example, the gaming application may utilize the USB output as a parameter, variable, and/or other input to the gaming application. In a flight simulation gaming application, for example, the USB output (e.g., associated with an input entered into the client device) may represent a desired direction and/or other action that a simulated aircraft should take. In some embodiments, the USB output may be processed (e.g., by the gaming and/or other application) as if it were received from an actual USB device such as a USB joystick and/or game pad (e.g., connected to the host PC).

According to some embodiments, the method 300 may continue at 306 by providing the information associated with the application. The application output (e.g., the application output 226) may, for example, be provided to a client device. In some embodiments, the application output may be provided to the client device and/or other device from which the emulated USB information was received. For example, the application output may be transmitted to the client device at least in part in response to the USB output information received at 302. According to some embodiments, such as in the case that the application is a gaming application, the application output may include graphics, sounds, video, and/or other gaming information. This information may, for example, be provided to the client device to allow a user of the client device to “play” the gaming application. In some embodiments, the gaming application may be executed and/or stored upon a host device and the client device may only require a thin-client (e.g., a client-side application and/or plug-in) to render the gaming application on the client device.

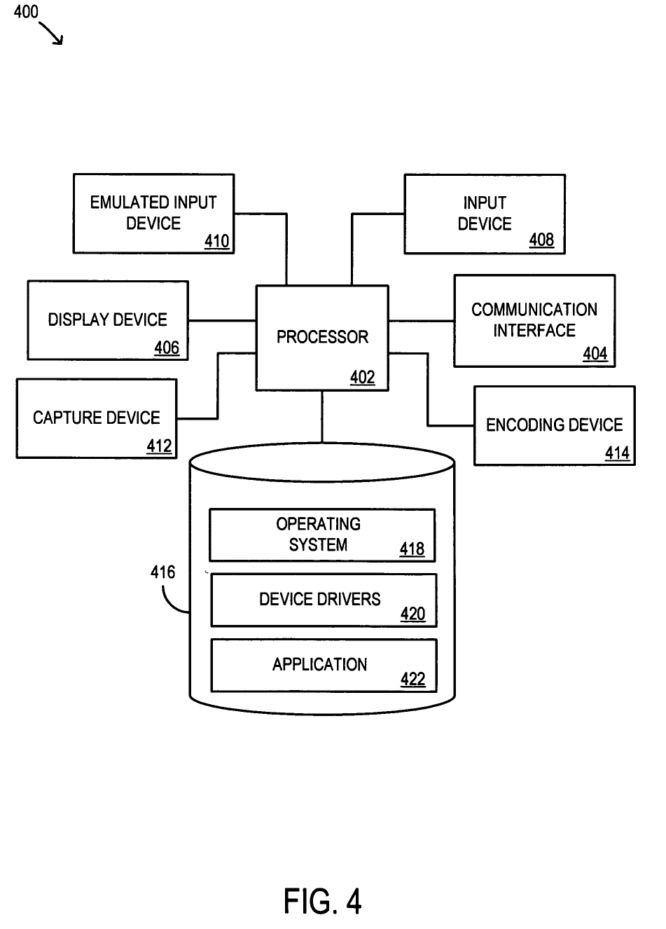

Turning now to FIG. 4, a block diagram of a system 400 according to some embodiments is shown. The system 400 may, for example, be utilized to implement and/or perform the method 300 described herein and/or may be associated with the systems 100, 200 described in conjunction with any of FIG. 1 and/or FIG. 2. In some embodiments, fewer or more components than are shown in FIG. 4 may be included in the system 400. According to some embodiments, different types, layouts, quantities, and configurations of systems may be used.

In some embodiments, the system 400 may be or include a computer such as a PC, a computer server, and/or a notebook computer. According to some embodiments, the system 400 may be a host computer such as the host device 120, 220 described herein. In some embodiments, the system 400 may be a computer utilized to facilitate the interface between one or more client devices and an application that accepts and/or requires USB outputs. The system 400 may include, for example, one or more processors 402, which may be any type or configuration of processor, microprocessor, and/or micro-engine that is or becomes known or available. In some embodiments, the system 400 may also or alternatively include one or more communication interfaces 404, a display device 406, an input device 408, an emulated input device 410, a capture device 412, an encoding device 414, and/or a memory device 416, all and/or any of which may be in communication with the processor 402. The memory device 416 may store, for example, an operating system 418, device drivers 420, and/or one or more applications 422.

The communication interface 404 may be or include any type and/or configuration of communication device that is or becomes known or available. In some embodiments, the communication device 404 may allow the system 400 (and/or the processor 402) to communicate with, for example, one or more client devices (e.g., client devices 110, 210). According to some embodiments, the communication interface 404 may be or include a Network Interface Card (NIC) such as an Intel® PRO/1000 MT Desktop Adaptor that operates in accordance with the Fast Ethernet LAN transmission standard 802.3-2002® published by the Institute of Electrical and Electronics Engineers (IEEE), or an Intel® PRO/Wireless 2225BG Network Connection that operates in accordance with the Wireless LAN transmission standard 802.11B/G-1999/2003® published by the IEEE.

The display device 406 may be or include any type of display device that is or becomes known or practicable, including, but not limited to, a Cathode Ray Tube (CRT) display device, a Liquid Crystal Display (LCD) device, and/or a Light-Emitting Diode (LED) display device. In some embodiments, the display device 406 may be similar to the display component 224 described in conjunction with FIG. 2 herein. The input device 408 may be or include one or more conventional devices such as a keyboard, a mouse, a trackball, etc. The input device 408 may be utilized, for example, by an operator and/or system user to interface with the operating system 418 and/or the application 422 running on the system 400 (e.g., executed by the processor 402) and/or to facilitate the interface between a client device and the application 422. In some embodiments, the input device 408 may be similar to the input components 222 described in conjunction with FIG. 2 herein.

According to some embodiments, the system 400 may include an emulated input device 410. The emulated input device 410 may, for example, be a client device and/or a representation of a client device. In some embodiments, the emulated input device 410 may be a client device that is treated like and/or viewed as a USB device and/or component by the system 400. The emulated input device 410 may, for example, be an emulated USB joystick and/or game pad. In some embodiments, the emulated input device 410 may be or include a driver (such as one of the device drivers 420) and/or other component and/or device that facilitates the interface between the system 400 and a client device.

In some embodiments, the system 400 may also or alternatively include the capture device 412 and/or the encoding device 414. The capture device 412 may, for example, be utilized to capture information from the application 422. In the case that the application 422 is a gaming application, for example, the capture device 412 may include a video capture device and/or an audio capture device. The capture device 412 may, according to some embodiments, record, store, and/or otherwise process output generated by the application 422. Information (such as emulated USB outputs) received from the emulated input device 410, for example, may be utilized by the application 422 to produce application output such as game graphics, video, and/or audio. The application output may, for example, be captured by the capture device 412 and provided to a client device (e.g., to allow the client device to render the game on the client device).

According to some embodiments, the application output may be encoded prior to providing the output to the client device. The encoding device 414 may, for example, encode the output information captured by the capture device 412. In some embodiments, such as in the case that the application output includes video and/or audio, the encoding device 414 may encode the information in accordance with the Moving Pictures Expert Group (MPEG) Release Two (MPEG-2) 13818 standard (1994) published by the International Standards Organization (ISO) and the International Electrotechnical Commission (IEC), and/or in accordance with the MPEG-4 14496 (1999/2002) standard published by ISO/IEC. The encoded information may then, for example, be transmitted to the client device for use in client-side game rendering.

The memory device 416 may be or include, according to some embodiments, one or more magnetic storage devices, such as hard disks, one or more optical storage devices, and/or solid state storage. The memory device 416 may store, for example, the operating system 418, the device drivers 420 (e.g., to interface with the input device 408, the display device 406, and/or the emulated input device 410), and/or the application 422. The device drivers 420 may, according to some embodiments, include one or more Windows® Human Interface Device (HID) drivers to provide an interface between a bus driver (such as a USB driver) and an input device (e.g., the emulated input device 410). In some embodiments, the device drivers 420 may also or alternatively include one or more other drivers and/or driver types such as one or more USB drivers.

The application 422 may be or include any type and/or configuration of application that is or becomes known. In some embodiments, the application 422 may be a software application such as a gaming application. The application 422 may, for example, include program code that is executable by the processor 402 to perform various functions. According to some embodiments, the application may be executed entirely within and/or on the system 400 (e.g., by the processor 402). In some embodiments, a component of the application 422 and/or a related application (e.g., a thin-client) may operate on a separate and/or distinct device and/or system. A client device may, for example, operate a gaming client associated with the gaming application 422 to facilitate rendering of the game on the client device.

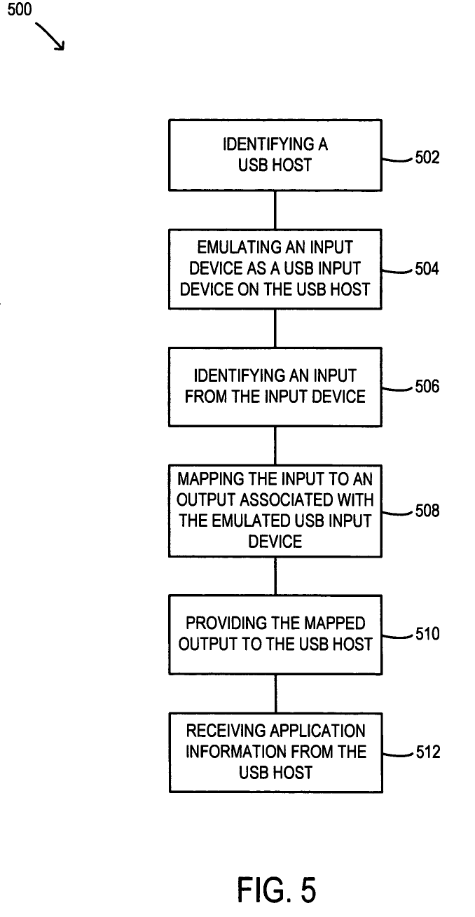

Referring now to FIG. 5, a method 500 according to some embodiments is shown. In some embodiments, the method 500 may be conducted by and/or by utilizing the systems 100, 200, 400 and/or may be otherwise associated with the systems 100, 200, 400 and/or any of the system components described in conjunction with any of FIG. 1, FIG. 2, and/or FIG. 4. The method 500 may, for example, be performed by and/or otherwise associated with the client device 110, 210 described herein.

In some embodiments, the method 500 may begin at 502 by identifying a USB host. A client device (such as a client device 110, 210) may, for example, perform a search for a host that is capable of providing USB bridging services. According to some embodiments, Bluetooth® technology may be used to actively discover a USB host. In some embodiments, the USB host may be otherwise identified, determined, and/or located. The USB host may, for example, transmit a signal to assist a client device in locating and/or identifying the USB host. In some embodiments, the client device may store a list of available USB hosts and/or may otherwise lookup an address, identifier, and/or locator associated with the USB host. In some embodiments, one or more available USB hosts may be selected, identified, and/or otherwise chosen.

According to some embodiments, the method 500 may continue by emulating an input device as a USB input device on the USB host, at 504. For example, the client device may include an input device and/or component (e.g., input component 212) and may emulate the input device as a USB input device on the host. In other words, a potentially non-USB input device (e.g., associated with the host) may be loaded, installed, and/or otherwise interfaced with the USB host (e.g., host device 120, 220) as a local USB device (e.g., local to the host). In some embodiments, the USB host may load a driver and/or otherwise install, initiate, and/or configure the emulated USB device. As an example, the client device may include a keypad that may be interfaced with the USB host as a USB joystick. In some embodiments, the client device itself may be the emulated USB device (e.g., the USB joystick, keyboard, and/or game pad). According to some embodiments, a software and/or other application on the client device, such as a USB control transfer application, may conduct the device emulation. In some embodiments, the emulation may also or alternatively be conducted by and/or at the USB host.

The method 500 may continue at 506 by identifying an input from the input device. The client device (and/or a component thereof) may, for example, monitor the input device (such as the keypad) to identify any input. The input may be received, for example, from a user of the client device. In some embodiments, the user may press a key of the keypad, for example. According to some embodiments, a software and/or other application on the client device, such as a USB interrupt transfer application, may conduct the identification of the input. In some embodiments for example, the keypad (and/or other input device) may be monitored by the USB interrupt transfer application to determine if an input is received.

In some embodiments, the method 500 may also or alternatively include mapping the input to an output associated with the emulated USB input device, at 508. In the case that the input is associated with a keypad, for example, the key-press initiated by the user may be mapped to a function associated with the emulated USB device. An emulated USB joystick, for example, may be capable of producing various outputs such as outputs associated with positive and negative vertical and/or horizontal axes (e.g., first and/or second axes), and/or outputs from various buttons, triggers, rollers, levers, and/or switches (e.g., a “hat” switch). In some embodiments, multiple possible inputs associated with the keypad (and/or other input component associated with the client device) may be mapped to multiple possible outputs that may be produced by a USB joystick (and/or other emulated USB input device). According to some embodiments, the mapping of input device inputs to emulated USB device outputs may be stored on and/or by the client device. In some embodiments, the mapping may be performed by a mapping application and/or device on the client device. The mapping may, according to some embodiments, be automatic and/or customizable by the user of the client device.

At 510, the method 500 may continue, for example, by providing the mapped output to the USB host. In some embodiments, the client device may convert the mapped output into a USB packet and transmit the packet over a network (e.g., network 130) to the USB host. An application resident on the client device may, for example, structure and/or package the mapped output information as a USB packet. The USB packet may, according to some embodiments, be sent to the USB host over an IP network. The USB packet may be received by the USB host, for example, as if it had originated from a local USB device (e.g., the emulated USB device). In some embodiments, a client device that lacks USB functionality may accordingly utilize the USB bridging services of the USB host to interface with an application that accepts and/or requires USB outputs. A handheld device such as a wireless telephone may, for example, be capable of interfacing with a gaming application running on a host computer as if the wireless telephone were and/or included a USB joystick and/or game pad.

In some embodiments, the method 500 may continue at 512 by receiving application information from the USB host. The USB host may process the USB packet received from the client device, for example, to produce application output. In some embodiments, the application running on the USB host may include a gaming application. The gaming application may, for example, processes the USB output from the emulated USB input device (e.g., the client device) and produce information associated with a game (e.g., audio and/or video). According to some embodiments, this game information (and/or other application output) may be transmitted and/or otherwise provided to the client device. The application output may, in some embodiments, be captured by the USB host from the application (e.g., audio and/or video capture). The captured information may be encoded, according to some embodiments, and sent to the client device. In some embodiments, the client device may decode the application output as is appropriate and/or may utilize the information to render the game (or other application) on the client device.

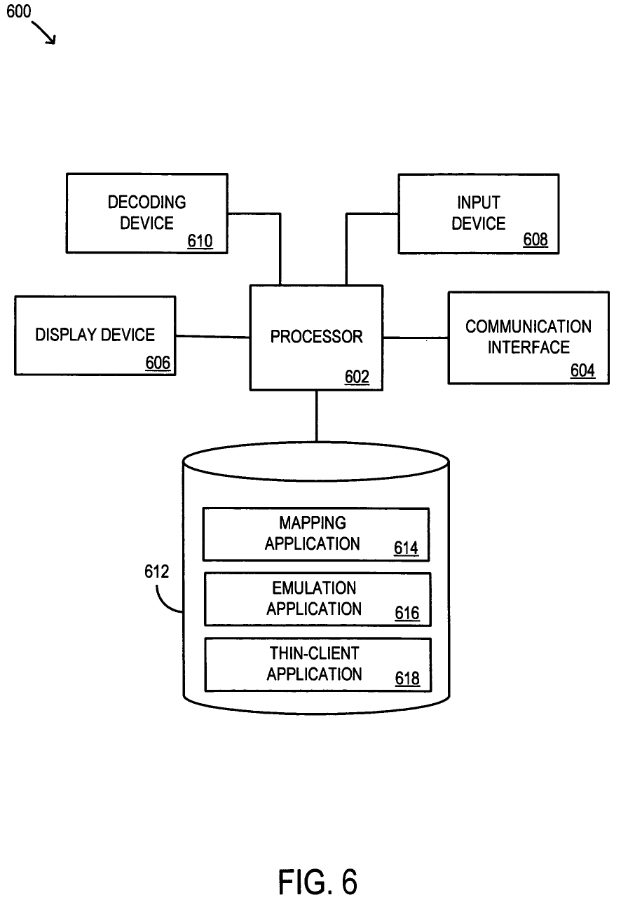

Turning now to FIG. 6, a block diagram of a system 600 according to some embodiments is shown. The system 600 may, for example, be utilized to implement and/or perform the method 500 described herein and/or may be associated with the systems 100, 200, 400 described in conjunction with any of FIG. 1, FIG. 2, and/or FIG. 4. In some embodiments, fewer or more components than are shown in FIG. 6 may be included in the system 600. According to some embodiments, different types, layouts, quantities, and configurations of systems may be used.

In some embodiments, the system 600 may be or include a network device such as a PC, a PDA, a wireless telephone, and/or a notebook computer. According to some embodiments, the system 600 may be a client device such as the client devices 110, 210 described herein. In some embodiments, the system 600 may be a portable computing device utilized to interface with a host device that provides USB bridging services to allow the portable computer to interface with an application that accepts and/or requires USB outputs. The system 600 may include, for example, one or more processors 602, which may be any type or configuration of processor, microprocessor, and/or micro-engine that is or becomes known or available. In some embodiments, the system 600 may also or alternatively include one or more communication interfaces 604, a display device 606, an input device 608, a decoding device 610, and/or a memory device 612, all and/or any of which may be in communication with the processor 602. The memory device 616 may store, for example, a mapping application 614, an emulation application 616, and/or a thin-client application 618.

The communication interface 604, the display device 606, and/or the input device 608 may be or include any types and/or configurations of devices that are or become known or available. In some embodiments, the components 604, 606, 608 of the system 600 may be similar in configuration and/or functionality to the similarly-named components described in conjunction with FIG. 4 herein. According to some embodiments, the input device 608 may include a keypad, one or more buttons, and/or one or more softkeys and/or variable function input devices. The input device 608 may include, for example, any input component of a wireless telephone and/or PDA device, such as a touch screen and/or a directional pad or button. In some embodiments, the input device 608 may be similar to and/or include the input components 212 described in conjunction with FIG. 2 herein.

In some embodiments, the system 600 may include the decoding device 610. The decoding device 610 may, for example, decode information received from a USB host. According to some embodiments, application output (e.g., gaming application output) may be encoded by a USB host and sent to the client device (e.g., at 512). The application output may then, for example, be decoded by the decoding device 610. In some embodiments, the decoding device 610 may be capable of decoding information in accordance with either or both of the MPEG-2 and MPEG-4 standards cited herein. Other forms, standards, and/or types of decoding (and/or encoding) may be performed by the decoding device 610 without deviating from some embodiments.

The memory device 612 may be or include, according to some embodiments, one or more magnetic storage devices, such as hard disks, one or more optical storage devices, and/or solid state storage. The memory device 612 may store, for example, the mapping application 614, the emulation application 616, and/or the thin-client application 618. The mapping application 614 may be any type of application, module, program, and/or device that is capable of mapping inputs (e.g., associated with the input device 608) to outputs (e.g., of an emulated USB device). The mapping application 614 may include, for example, a key mapping application that maps keys of an input device (e.g., keypad keys) to outputs associated with another device (e.g., an emulated USB device). In some embodiments, the mapping application 614 may include a Graphical User Interface (GUI) that allows a user of the system 600 to customize and/or manage the mapping process. According to some embodiments, the mapping application 614 may automatically map inputs associated with the system 600 (e.g., of the input device 608) to outputs associated with an emulated USB device (e.g., at 508).

The emulation application 616 may be or include, for example, a USB control transfer module and/or application that is capable of emulating and/or facilitating the emulation of a USB device. The emulation application 616 may, according to some embodiments, emulate a USB device (e.g., at 504) by providing mapped outputs as USB packets to a host device over an IP network. The USB packets (and/or other form and/or configuration of output information provided by the emulation application 616) may, for example, be utilized by the host device as if they were received from a locally connected USB device (e.g., local to the host).

In some embodiments, the thin-client application 618 may include software and/or code that facilitates the rendering of an application on the system 600 (e.g., the client device). The thin-client application 618 may, for example, include an application associated with an application running on a host device. In some embodiments, such as in the case that the application executed by the host device is a gaming application, the thin-client application 618 may be a thin-gaming client. The thin-client application 618 may, for example, utilize application output received from the host device (and/or decoded by the decoding device 610) to render the host application (e.g., the game) on the system 600. According to some embodiments, any or all of the mapping application 614, the emulation application 616, and the thin-client application 618 may be included within and/or as part of a single software and/or application module, package, and/or program. The thin-client application 618 may, for example, include the functionality of all applications that are desired and/or needed for client-side application (e.g., game) rendering.

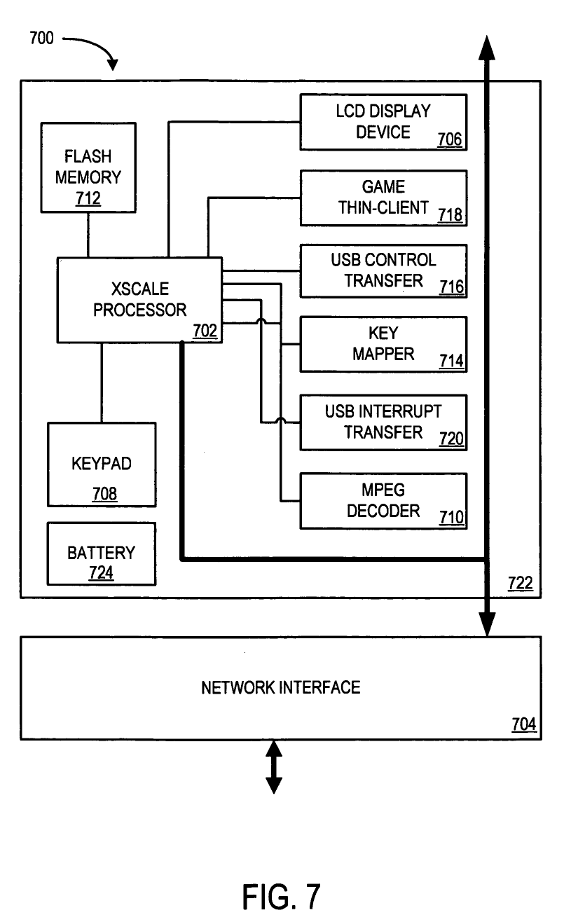

Turning now to FIG. 7, a block diagram of a system 700 according to some embodiments is shown. The system 700 may, for example, be associated with the method 500 described above and/or may be similar in configuration and/or functionality to the systems 100, 200, 400 described in conjunction with FIG. 1, FIG. 2, and/or FIG. 4. In some embodiments, the system 700 may be or include a mobile electronic device (and/or other network device) such as the client devices 110, 210 described herein. Fewer or more components that are shown in FIG. 7 may, according to some embodiments, be included in the system 700. In some embodiments, the components 702, 704, 706, 708, 710, 712, 714, 716, 718 of the system 700 may be similar in configuration and/or functionality to the similarly-named components described in conjunction with FIG. 6 herein.

The system 700 may, according to some embodiments, include an XScale® Processor 702 (such as an Intel® PXA270 XScale® processor), a network interface 704, an LCD display device 706, a keypad 708, an MPEG decoder 710, flash memory 712, a key mapper 714, a USB control transfer 716, a game thin-client 718, and/or a USB interrupt transfer 720. The XScale® processor 702 may, according to some embodiments, include a built-in keypad interface (not shown) for facilitating communication between the processor 701 and the keypad 708. In some embodiments, the network interface 704 may be a separate device and/or component. As shown in FIG. 7 for example, the system 700 may include a mobile platform 722 (e.g., a notebook computer, PDA, and/or wireless telephone) coupled with the network interface 704, which may be or include, for example, a NIC and/or other communication interface device. In some embodiments, the system 700 may be a mobile platform and/or other electronic device that includes both the mobile platform 722 and the network interface 704.

In some embodiments, the mobile platform 722 may utilize the network interface 704, for example, to communicate with one or more host devices over one or more networks. The system 700 may, according to some embodiments, communicate with a host device to implement embodiments as described herein. The USB control transfer 716 may, for example, emulate the keypad 708 as a USB device local to the host computer. In some embodiments, the key mapper 714 may map one or more keys (e.g., inputs) of the keypad 708 to one or more outputs associated with the emulated USB device. The mapping information and/or sequence may, for example, be stored in the flash memory 712.

A user operating the system 700 (and/or otherwise associated with the system 700) may, according to some embodiments, press a key of the keypad 708 (e.g., to interface with a remotely executed game accepting USB inputs). The USB interrupt transfer 720 may monitor the keypad 708 and/or may otherwise detect and/or determine that an input has been received (e.g., the key press). In some embodiments, the USB control transfer 716 may utilize the detected input along with the stored mapping information to create; identify, and/or otherwise determine a USB packet associated with the input. The USB control transfer 716 may, for example, construct a USB packet containing emulated USB device output information associated (e.g., via the mapping) with the received input (e.g., the key press).

In some embodiments, the USB packet may be transmitted (e.g., via the network interface 704) to a host and/or a remote host over an IP network (and/or another type of network). The host may utilize the USB packet as if it were received from a locally-connected USB device. The host may, for example, supply the emulated USB output to an application running on the host device (such as a gaming application). In some embodiments, the system 700 may receive application output from the host device. The MPEG decoder 710 may, for example, decode any received information (e.g., captured and encoded gaming audio and/or video) and provide the information to the game thin-client 718. According to some embodiments, the game thin-client 718 may utilize the application output received from the host device to render the game on the system 700.

Rendering the game may include, for example, providing the audio and/or video associated with the game to a user of the system 700. In some embodiments, the gaming information may be provided via the LCD display device 706 and/or other components (not shown) as is practicable and/or appropriate. The game thin-client 718 may also or alternatively perform functions other than providing the received gaming information to the user. The game thin-client 718 may, for example, undertake and/or facilitate the mapping process, perform various gaming calculations and/or lookups, and/or otherwise perform functions associated with facilitating the interaction between the user of the system 700 and the gaming application running on the host device. In some embodiments, the system 700 may also or alternatively include a battery 724. The battery 724 may, for example, provide power to any or all of the components of the system 700 and/or the mobile platform 722. The battery 724 may be or include any type and/or configuration of power supply that is or becomes known or practicable.

The several embodiments described herein are solely for the purpose of illustration. Those skilled in the art will note that various substitutions may be made to those embodiments described herein without departing from the spirit and scope of the present invention. Those skilled in the art will also recognize from this description that other embodiments may be practiced with modifications and alterations limited only by the claims.

What is claimed is:

1. A method, comprising:
receiving information associated with an emulated universal serial bus input device;
processing the received information in accordance with an application to produce application information associated with the application; and
providing the application information.

2. The method of claim 1, wherein the received information is received as a universal serial bus packet.

3. The method of claim 2, wherein the universal serial bus packet is received via an internet protocol network.

4. The method of claim 1, further comprising:
loading a driver associated with the emulated universal serial bus input device.

5. The method of claim 1, further comprising:
capturing the information associated with the application.

6. The method of claim 1, wherein the information associated with the application includes at least one of video information or audio information.

7. The method of claim 1, further comprising:
encoding the information associated with the application.

8. The method of claim 1, wherein the received information includes information associated with an input detected by a portable wireless device.

9. The method of claim 8, wherein the detected input includes a keystroke entered into the portable wireless device.

10. The method of claim 9, wherein the keystroke is mapped to an output of the emulated universal serial bus input device.

11. The method of claim 1, wherein the application is a game.

12. The method of claim 1, wherein the providing comprises:
sending the information associated with the application to a portable wireless device.

13. An apparatus, comprising:
a storage medium having stored thereon instructions that when executed by a machine result in the following:
receiving information associated with an emulated universal serial bus input device;
processing the received information in accordance with an application to produce application information associated with the application; and
providing the application information.

14. The apparatus of claim 13, wherein the instructions, when executed by a machine, further result in the:
sending the information associated with the application to a portable wireless device.

15. The apparatus of claim 13, wherein the information associated with the emulated universal serial bus input device is received as a universal serial bus packet via an internet protocol network.

16. A system, comprising:
an electronic device, including:
a memory device to store an application;
an emulated universal serial bus input device;
a processor to process information from the emulated universal serial bus input device in accordance with the application to produce information associated with the application; and
a network device to send the information associated with the application to a portable wireless device.

17. The system of claim 16, wherein the electronic device further includes:
a capture device to capture the information associated with the application.

18. The system of claim 16, wherein the electronic device further includes:
an encoding device to encode the information associated with the application.

19. The system of claim 16, wherein the information from the emulated universal serial bus input device is received as a universal serial bus packet via an internet protocol network.

20. A method, comprising:
identifying a universal serial bus host;
emulating an input device as a universal serial bus input device on the universal serial bus host;
identifying an input received from the input device;
mapping the input received from the input device to an output associated with the emulated universal serial bus input device;
providing the mapped input to the universal serial bus host; and
receiving application information associated with the mapped input from the universal serial bus host.

21. The method of claim 20, further comprising:
decoding the information received from the universal serial bus host.

22. The method of claim 20, further comprising:
storing information associated with the mapping in a memory device.

23. The method of claim 20, wherein the identifying the input received from the input device comprises:
monitoring the input device.

24. The method of claim 20, wherein the input device is a keypad.

25. The method of claim 24, wherein the keypad is to emulate a universal serial bus keyboard on the universal serial bus host.

26. The method of claim 20, wherein the application information is associated with a gaming application.

27. A system, comprising:
a portable wireless electronic device, including:
an input device to receive an input;
an emulation device to emulate the input device as a universal serial bus device on a host; and
a battery to provide power to the device.

28. The system of claim 27, wherein the portable wireless electronic device further includes:
a decoding device to decode information received from the host.

29. The system of claim 27, wherein the portable wireless electronic device further includes:
a memory device to store a thin-client application associated with a gaming application run on the host.
